(19) United States
(12) Patent Application Publication
(10) Pub. No.: US 2017/0200230 A1
(43) Pub. Date: Jul. 13, 2017

(54) CALL LEVEL PRICE ALERTS

(71) Applicant: FIDESSA PLC, London (GB)

(72) Inventors: Anthea Mars, London (GB); Daniel Langmead, Essex (GB); Bruce Bland, Chesham (GB); Rob Smith, Surrey (GB); Simon Halson, Reading (GB); Daniel Nicholass, Carshalton (GB); Oleh Danyliv, London (GB)

(21) Appl. No.: 15/404,836

(22) Filed: Jan. 12, 2017

Related U.S. Application Data
(60) Provisional application No. 62/278,192, filed on Jan. 13, 2016.

(51) Int. Cl. G06Q 40/04; G06Q 10/10

(52) U.S. Cl. CPC G06Q 40/04; G06Q 10/107

(57) ABSTRACT

The present disclosure generally relates to techniques for monitoring, displaying, and alerting users of market instrument information, and more particularly, to techniques for monitoring, displaying, and alerting users to call levels generated based on user-defined parameters. Embodiments of the present disclosure allow users to monitor multiple market instruments across exchanges via a graphical user interface displaying call level entries generated based on user-defined parameters and to be alerted when one or more conditions arise. The presently disclosed subject matter also monitors call level status such as by indicating whether the call level entry is inactive, expired, and the like. Additionally, the subject matter allows users to manually or automatically submit one or more orders to be executed when certain conditions arise. Overall, the disclosed subject matter provides a more efficient workflow for real-time financial monitoring.

### CROSS REFERENCE TO RELATED APPLICATIONS

This application claims benefit of U.S. Provisional Patent Application No. 62/278,192 filed Jan. 13, 2016, the entirety of which is herein incorporated by reference.

### BACKGROUND

Traders engaged in the trading of financial instruments can utilize software products that provide various graphical user interfaces to display market price data, execute orders, and monitor status of different market conditions. Market instruments can include anything that can be traded in some quantity for a particular price. For example, a market instrument can be goods or financial products (e.g., stocks, bonds, futures, currency, commodities, or other financial instruments). Market instruments may be “real” and listed on an exchange or “synthetic,” such as a combination of real products.

Electronic trading of market instruments has been embraced as the means for buying and selling instruments in various market exchanges throughout the world. Traders can communicate with host computers of the market exchanges or other intermediary host computers coupled with the exchanges via personal computer or mobile device. Electronic trading allows for the display of information regarding market instruments received from the host computer which can impact the decision making process of the trader with regard to placing orders.

Traders engaged in electronic trading often process and absorb voluminous market information made available to them while trading. Certain exchanges can be fast-paced, fluid environments where price, quantity, and other market criteria constantly fluctuate within a short period of time. Certain types of market instruments can be traded during specified times and at specified prices. Thus, certain types of information about market instruments that can be important to traders can include the expiration, strike price, and other information relating to the status of an order if an order is placed for the market instrument. For example, with respect to options contracts, types of information that can impact a trader's decision to trade an option can include the current price of the option, the option's strike price and expiration, and the desired price for that instrument.

Conventional techniques for monitoring the movement of market instruments are complex and as such can be cumbersome and difficult to read and absorb. Such conventional techniques additionally frequently offer only limited functionality or fail to provide status information and alerts, which can be beneficial in making certain decisions to trade a market instrument or developing an investment strategy. Additionally, such conventional techniques offer limited price information about market instruments across exchanges with real-time data from the various exchanges.

Accordingly, there is a need for improved techniques for the display, monitoring, and alerting of market instrument information.

### SUMMARY

The present disclosure generally relates to techniques for monitoring, displaying, and alerting users of market instrument information, and, more particularly, to techniques for monitoring, displaying, and alerting users to call levels generated based on user-defined parameters.

The subject matter of the present disclosure allows users to monitor multiple market instruments across exchanges via a graphical user interface displaying call level entries generated based on user-defined parameters and to be alerted when one or more conditions arise. The presently disclosed subject matter also monitors call level status such as by indicating whether the call level entry is inactive, expired, and the like. Additionally, the subject matter allows users to manually or automatically submit one or more orders to be executed when certain conditions arise. The disclosed subject matter provides a more efficient workflow for real-time financial monitoring.

In one embodiment, a method for monitoring and managing price levels is disclosed. The method includes receiving a plurality of call level indicators into a call level grid via a call level entry ticket, determining supported codes, and determining a priority for each call level indicator received. The call level entry ticket tracks instruments within a market data grid and tracks a client and an account from a client-account grid. The priority is based on factors derived from historical real-time market data. The method further includes monitoring a price level related to each call level indicator received, wherein the monitoring is based on historical and real-time market data for each of the plurality of call level indicators received, and initiating a call level alert upon a trigger or an expiry of the price level.

In another embodiment, a computer system for monitoring and managing price levels is disclosed. The computer system includes one or more processors and a memory. The memory stores instructions that, when executed by the one or more processors, cause the computer system to carry out the method disclosed above.

In another embodiment, a non-transitory computer-readable medium storing instructions that, when executed by a processor, cause a computer system to monitor and manage price levels is disclosed. The non-transitory computer-readable medium performs the operations to carry out the method disclosed above.

### BRIEF DESCRIPTION OF THE DRAWINGS

FIG. 1 illustrates an exemplary call level entry ticket in accordance with an embodiment of the disclosed subject matter.

FIG. 2 illustrates an exemplary client-account list in accordance with an embodiment of the disclosed subject matter.

FIG. 3 illustrates an exemplary call level entry display grid in accordance with an embodiment of the disclosed subject matter.

FIG. 4 illustrates an exemplary market data display grid in accordance with an embodiment of the disclosed subject matter.

FIG. 5 illustrates exemplary call level states in accordance with an embodiment of the disclosed subject matter.

FIG. 6 illustrates an exemplary call level entry display grid in accordance with another embodiment of the disclosed subject matter.

FIG. 7 illustrates an exemplary call level entry display grid in accordance with another embodiment of the disclosed subject matter.

FIG. 8 illustrates an exemplary audit trail in accordance with an embodiment of the disclosed subject matter.

FIG. 9 illustrates an exemplary graphical user interface in accordance with an embodiment of the disclosed subject matter.

FIG. 10 schematically illustrates operations of a method for monitoring and managing price levels, according of one embodiment disclosed herein.

### DETAILED DESCRIPTION

Certain exemplary and non-limiting embodiments of the disclosed subject matter will be described below with reference to the figures for the purposes of illustration and not limitation. It should be apparent, however, to those skilled in the art that many more modifications besides those described herein are possible without departing from the concepts of the disclosed subject matter.

In one aspect of the present disclosure, a monitoring system for monitoring, displaying, and/or alerting users to call level information associated with one or more market instruments traded on one or more exchanges can comprise one or more computing devices that can include one or more processors configured with software components to generate an interactive tool displayable to users. The monitoring system of the disclosed subject matter can further comprise a network for providing communication and connectability to the one or more computing devices. The monitoring system of the disclosed subject matter can further comprise one or more servers, which can provide storage and access capabilities for storing information to be delivered to users and, additionally or alternatively, information received from users. The one or more processors of the computing device can be configured to receive and aggregate market data corresponding to one or more market instruments on one or more exchanges via the network, wherein the market data can be stored by the one or more servers. For example, the market data can comprise historical and real time market trade information such as trade volumes, price quotes including bid and ask, strike price, and expiration.

In accordance with an exemplary and non-limiting embodiment, the computing device can be configured to create one or more call level entry tickets comprising one or more user-defined parameters in order to generate call level entries for the monitoring system to monitor and output to the computing device. The call level entry ticket can be generated via the interactive tool displayable to users, such as for example, a graphical user interface (GUI) or other interactive desktop tool or application. For example, the interactive tool can comprise a graphical user interface comprising interactive windows having graphical control elements such as drop-down menus, dialog boxes, buttons, toolbars, and the like, allowing users to submit information via a call level entry ticket to the monitoring system to create the one or more call level entries. For example, a call level entry ticket can comprise the following list of exemplary parameters: market instrument, desired price level, desired start time, desired end time or duration, and order entry information such as, for example, quantity and the like. A call level entry ticket can also comprise graphical control elements giving the user the option to add alerts to be triggered when certain conditions arise. For example, the call level entry ticket can comprise fields for submitting alert delivery information such as one or more email addresses. Additionally, or alternatively, users can submit the type or combination of types of alert delivery methods such as a desktop alert and an email alert. Desktop alerts can comprise notifications rendered on computer screens or screens of other electronic devices. Alert delivery methods can include other types of delivery methods such as SMS (Short Message Service).

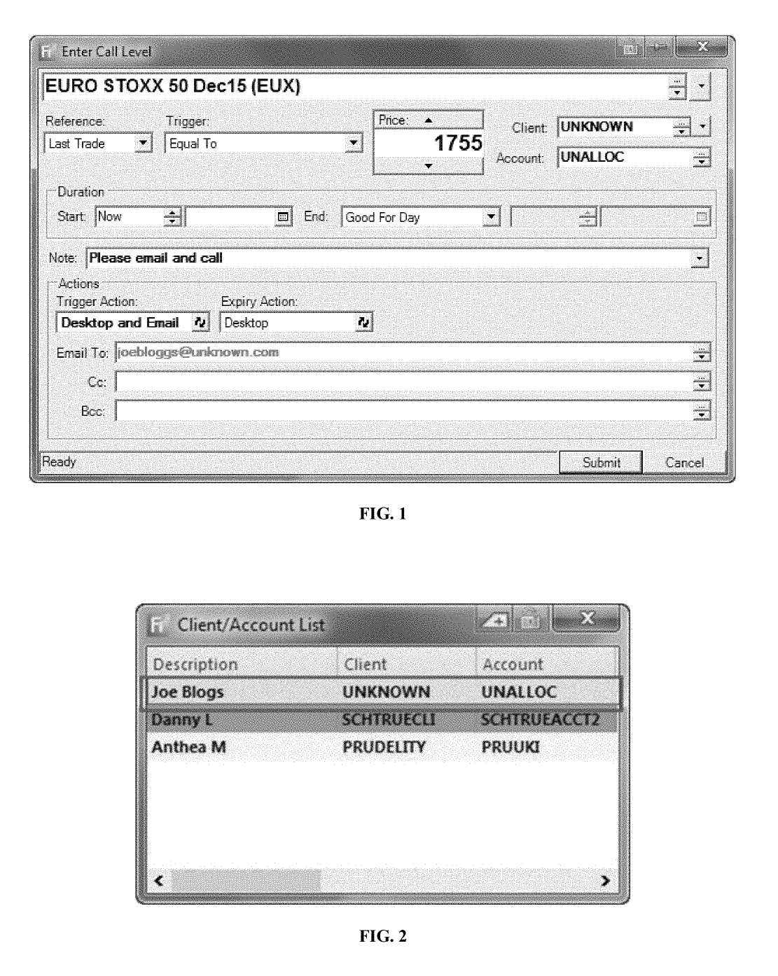

An exemplary call level entry ticket is depicted below in FIG. 1. Although particular aspects are illustrated in FIG. 1, one of skill in the art will appreciate that, based on the disclosure herein, the order entry ticket can be varied and presented in a number of different configurations as desired.

In certain embodiments, the monitoring system can be configured to provide default values to certain parameters of the call level entry ticket. The default values can be preset for a particular client, account, or a particular market instrument. The default values can be stored in the one or more servers of the monitoring system of the herein disclosed subject matter, along with, for example, the client and account information and market data.

In certain embodiments, a user can additionally and/or alternatively enter free form text into a field of the call level entry ticket for providing notes, instructions, and/or other commentary along with the alert in the event of call level trigger as depicted in exemplary FIG. 1.

In certain embodiments, one or more call level entry tickets can be created automatically and in bulk based on a list of call level information. For example, such call level information can be provided in a spreadsheet or other electronic document providing data arranged in rows, which can be imported into the monitoring system and used to generate one or more call level entries without the user having to manually define every parameter.

In certain embodiments, users can create, via the interactive tool of the computing device, client-account lists to be stored by and retrieved from the one or more servers of the monitoring system. The client-account lists can comprise details of the client and corresponding account. Additionally, or alternatively, the client-account list can comprise descriptions entered by the user via the interactive tool. The user can create call level entry tickets using the client-account lists. By way of example, certain parameters of the call level entry ticket can be automatically populated when the user selects a row of the client-account list. An exemplary client-account list is depicted for the purposes of illustration and not limitation in FIG. 2, below.

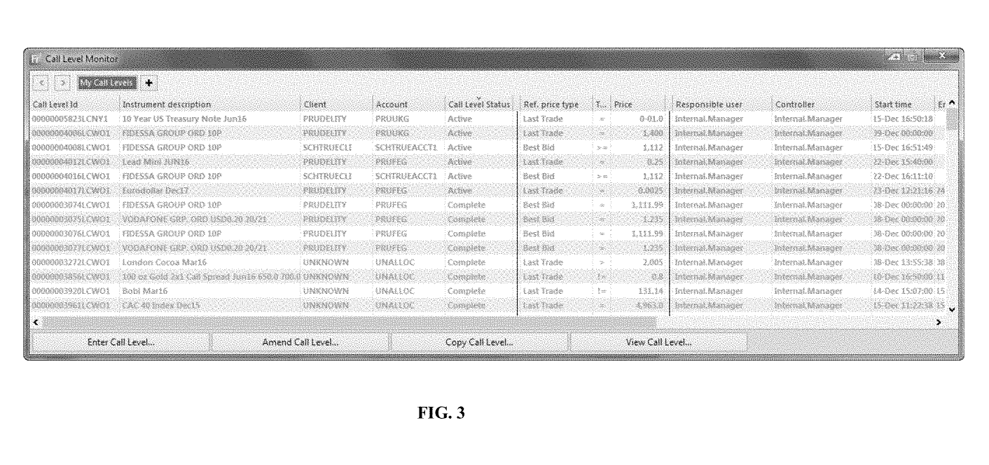

In another aspect of the disclosed subject matter, the interactive tool of the computing device can be configured to generate a graphical display, such as a grid, matrix or other tabular display, for displaying one or more call level entries. The grid can comprise a panel having rows, columns, and column headers; and graphical control elements, such as toolbars, drop-down menus, scrollbars, and buttons for controlling the display of content. An exemplary grid is depicted in FIG. 3.

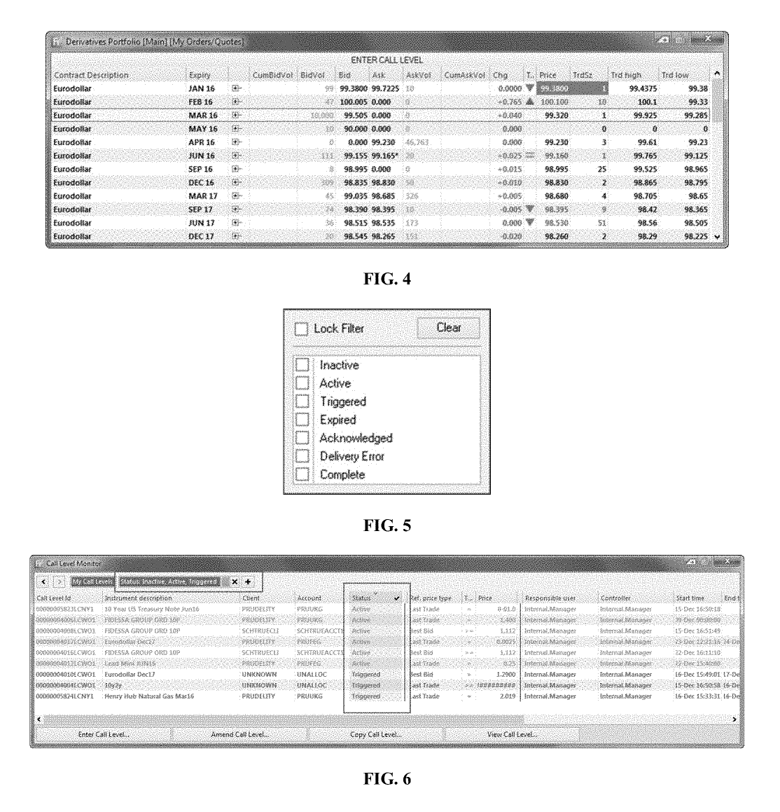

The interactive tool of the computing device can additionally be configured to generate a graphical display, such as a grid, or matrix or other tabular display, for displaying market data of market instruments of interest. For example, the grid can be configured to display market data for market instruments selected by the user via the interactive tool, and additionally or alternatively, display all instruments in the user's portfolio, such as the user's derivatives portfolio illustrated below in FIG. 4. The grid can comprise a panel having rows, columns, and column headers; and graphical control elements, such as toolbars, drop-down menus, scrollbars, and buttons for controlling the display of content. In certain embodiments of the disclosed subject matter, the grid displaying market data corresponding to one or more market instruments can comprise graphical control elements for accepting user input gestures such as, for example, pressing a button, wherein the gesture can cause the interactive tool to display or automatically generate a call level entry ticket for one or more market instruments, as illustrated in FIG. 4.

Additionally, or alternatively, in certain other embodiments of the disclosed subject matter, the computing device of the monitoring system can be configured to generate graphical displays in a prioritized order. For example, the computing device of the monitoring system can be configured to prioritize the graphical display of call level entries based on those likely to trigger. For example, the monitoring system can comprise software components configured with logic to determine call level entries likely to trigger based on trends in historical and real time market data received from one or more exchanges. For example, call level priority can be based on the volatility of each individual instrument, which can be used to compute the likelihood that the price of the instrument will trigger the call level. Additionally, or alternatively, in yet other embodiments the computing device can be configured to allow sharing of call level entries, such as for example upon receiving user input the sharing of call level entries can be between users, third parties, and the like. For example, the call level entries can be shared with clients' authorized associates or advisors.

In another embodiment, call level information can be imported via a spreadsheet program (for example, an Excel spreadsheet), and can include single or multiple call levels. As such, call levels received in spreadsheet format from a client can be imported in bulk into the call level system. In certain embodiments, the spreadsheet data can be copied and pasted in an FTW grid. As such, to import call levels the call level data, which can include headings, is copied and from the pre-formatted spreadsheet program to a clipboard of the call level system and subsequently pasted such that all attributes of the call levels are imported. In some embodiments, the call levels can be edited and/or cleared prior to entry from the FTW grid. Furthermore, errors in the call level information or grid data may be highlighted or contextualized to disclose the specific error.

In another aspect of the disclosed subject matter, the monitoring system comprising one or more computing devices including one or more processors can be configured to continuously update the market information and user-defined parameters, and update or modify the graphical displays of market data and call level entries. In certain embodiments, the grid or graphical display of call level entries can be configured to represent call level states. Call level states can reflect the status of the call level entry, such as for example and not limitation, that the call level is inactive, active, triggered, expired, acknowledged, in error, or complete, as depicted in FIG. 5.

In certain embodiments, the states of the call levels can be represented by different colors on the graphical display. An exemplary graphical display for displaying and representing the state of one or more call level entries is illustrated in FIG. 6. For example, and not limitation, a triggered call level can be represented in the color red, whereas an expired call level can be represented by the color black and an active call level by the color green. Additionally and/or alternatively, the computing device of the monitoring system can be configured to accept user input defining which particular states of the call level to monitor, such as for example via a drop-down menu, button, or other graphical control element.

In another aspect of the disclosed subject matter, the monitoring system comprising a computing device including one or more processors can be configured to transmit call level alerts via a network, such as for example, when the call level price is triggered. Additionally, the system can be configured to transmit to one or more users and/or one or more client alerts upon expiration of the call, or upon other state changes as desired. The delivery methods of the alerts can be defined by the user or provided as a default value in the order entry ticket. In certain embodiments, the interactive tool of the monitoring system can comprise a graphical user interface having graphical control element to provide the user the option to share call level alerts with one or more other users, clients, and/or third parties, such as for example by a graphical control element in the order entry ticket.

The monitoring system can be configured to perform electronic validation to check the user submitting a call level entry ticket against the client account information for security. By way of example and explanation, and not limitation, the monitoring system can extract email information from the call level entry ticket and check the email address against the client account information stored in the one or more servers. The system can further be configured to deliver a confirmation or validation email to the email address associated with the client and request approval to define or amend one or more the call level entries. In certain embodiments, the confirmation or validation email can include an expiration by which to complete the validation process after it is received at the client's email account. It is contemplated that in some embodiments the client and/or account fields of the call level entry ticket can be populated manually, such as from a drop down menu, a client account, or an Excel upload.

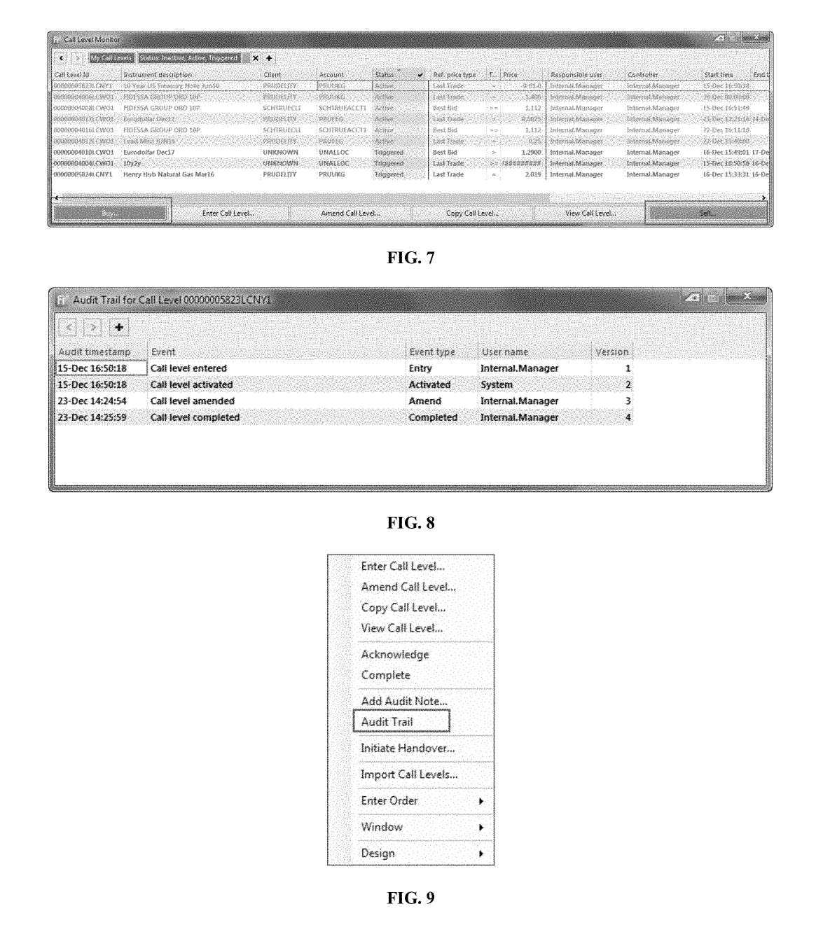

In certain embodiments of the disclosed subject matter, the monitoring system can be configured to launch an order either manually by a user or automatically, based on information provided in the call level entry ticket and client account information. By way of example and not limitation, the call level entry ticket can be populated with client account information; order information such as market instrument, exchange, quantity, desired price, expiry, and the like; and, or alternatively, default parameters. Accordingly, the monitoring system of the disclosed subject matter can be configured to directly execute an order to one or more exchanges via direct market access (DMA) or, alternatively, transmit the order to a broker or other intermediary host computers coupled with the exchanges. Thus, the monitoring system can comprise one or more software components to provide communication via a standardized electronic messaging protocol, such as, for example and not limitation, FIX or SWIFT. For example, the grid displaying call level entries can be configured with graphical control elements that can instruct the monitoring system to launch an order based on user input gestures such as the press of a button. Such a graphical display is depicted in FIG. 7.

In certain embodiments of the present disclosure, the monitoring system can be configured to generate audit trails for each call level entry. In the presently disclosed subject matter, audit trails can comprise time-stamped information of actions or events, such as for example an amendment or status change, made to an individual call level. The audit trail can comprise, but is not limited to, the following information: date and time information, event or status, user name, and version, where the version can reflect the version of the software components used to generate the monitoring system of the when the audit takes place. An exemplary audit trail is depicted in FIG. 8, below, for the purpose of illustration and not limitation. In certain embodiments, a user can view the audit trail for a given call level from the grid or graphical display of call level entries for example by right-clicking on a call level entry listed on the grid, and selecting to view the audit trail, as depicted in FIG. 9.

In certain embodiments, the monitoring system can be configured to allow multiple users to interact with a call level. For example and not limitation, a call level entry ticket can indicate one or more users or groups of users having authorization to interact with or work on the given call level, rather than limiting interaction with a call level to an individual user. In certain embodiments, one or more call level entries can be re-directed to be handled by different regions. For example and not limitation, call level entries handled by one or more users or groups of users at one trading desk can be transferred to one or more users or groups of users at another trading desk, wherein the trading desks can be located in different geographical regions.

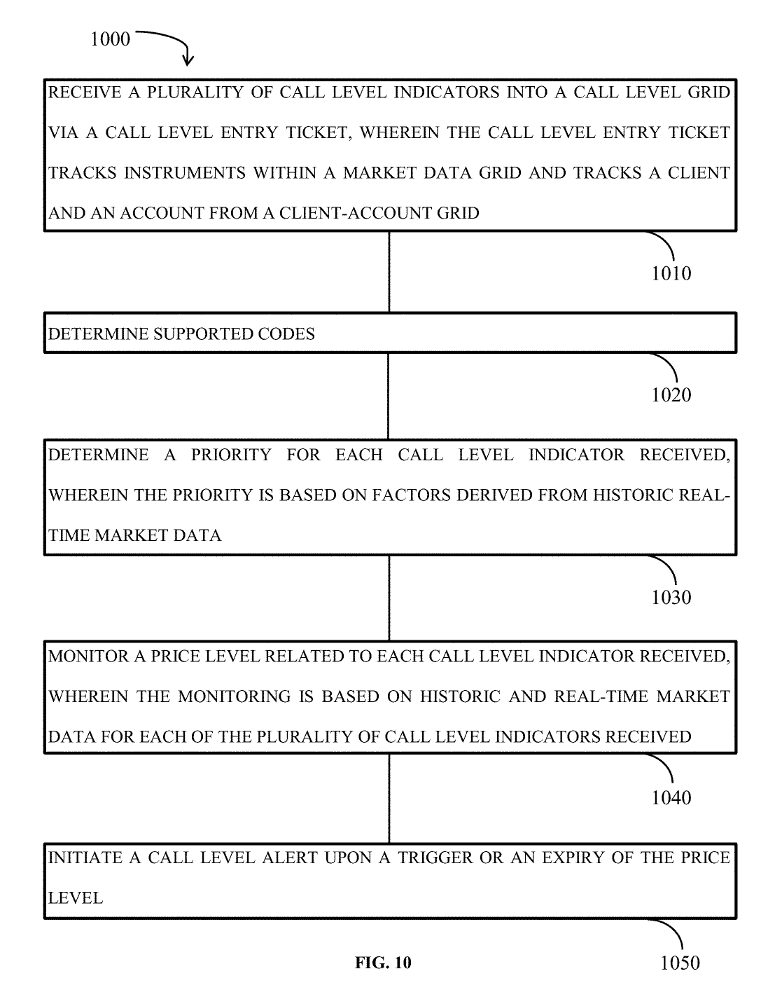

FIG. 10 schematically illustrates operations of a method 1000 for monitoring and managing price levels. The method 1000 allows for manual single price level alerts to be directly applied into a call level entry ticket. The call level entry ticket can track instruments within a market data grid. Furthermore, the call level entry ticket can track the client and the account from a client-account grid. As such, the method 1000 allows for the bulk upload of multiple price level alerts directly into the call level grid. At operation 1010, a plurality of call level indicators are received by a call level grid via a call level entry ticket. The call level entry ticket tracks instruments within a market data grid. Each call level indicator includes at least one user-defined parameter. Furthermore, the call level entry ticket tracks a client and an account from a client-account grid. In certain embodiments and, as described supra, each call level indicator can have an audit trail attached thereto. Audit notes can be added at any stage throughout the call level lifecycle.

At operation 1020, supported codes are determined. The bulk upload functionality, described supra, recognizes and/or accepts customized FIM codes as well as, for example, supported Bloomberg codes.

At operation 1030, a priority for each call level indicator received is determined. The priority is based on factors derived from historical and real-time market data.

At operation 1040, a price level related to each call level indicator received is monitored. The monitoring is based on historical and real-time market data for each of the plurality of call level indicators received.

At operation 1050, a call level alert is initiated upon a trigger or an expiry of the price level. The initiating of the call level alert includes preparing and sending a message via electronic mail or displaying the message via a desktop pop-up window, for example, on a graphical user interface. In some embodiments, the initiating of the call level alert includes both preparing and sending a message via electronic mail and displaying the message via a desktop pop-up window. In certain embodiments, the electronic mail, the electronic mailing address, and/or the addressee can be validated prior to the sending of the message. The validating can include comparing the addressee against a broker or a user and an end client requesting the call level alert. As such, the email validation is checked against both the broker/user and the end client requesting the call level.

In some embodiments, the method 1000 can also include receiving instructions in response to the call level alert. Moreover, in certain embodiments, call levels can be set to start at a time in the future, and the duration can be specified. Also, call levels can be copied from all call level monitor and alert grids.

Supported call level states include, by way of example only, inactive, active, triggered, expired, acknowledged, delivery error, and complete, among others. In some embodiments, each call level state may be defined by a specific color to visible highlight when a change of state occurs.

Benefits of the present disclosure include that users in the same group(s) can view and interact with existing call levels. Furthermore, the present disclosure allows for the ability to provide single or multiple call levels to different regions. Also, a user can launch an order entry ticket directly from the call level monitor and triggered call level grid. The order entry ticket can be pre-populated with the instrument, client, and account fields. Furthermore, a user can enter a call level from a button within a derivatives portfolio toolbar. Additional benefits include the ability to prioritize call levels, and specifically, prioritize call levels indicating the most likely to trigger. Also, in some embodiments, a SMS message(s) may be sent upon trigger or expiry to provide further notification. The present disclosure allows for the placement of a call level directly from any charting capability within the front end. As such, it can maintain the ability to be placed off of any charting analytics available. Also, call level functionality is a more efficient workflow and removes opportunity to misprice alerts on markets that are not a current primary focus.

The techniques disclosed herein can support outright futures and options instruments in addition to native and synthetic strategies. Additionally, it should be apparent to one of ordinary skill in the art that the unconventional techniques disclosed herein can be combined with other market analytics and/or charting tools, for example, as an application overlay or integrated object, to allow users to create call level entries from those tools. By way of example and not limitation, the monitoring system herein disclosed can be integrated with other analytics and/or charting tools in the form of an object such as a drop pin or other position marker in order to create call level entry based on information defined by the analytics and/or charting tool at the position on which the pin or marker is dropped. In this example, the monitoring system can alert the user when the tool reaches the pin or marker.

Although one or more embodiments have been described herein in some detail for clarity of understanding, it should be recognized that certain changes and modifications can be made without departing from the spirit of the disclosure. The embodiments described herein can employ various computer-implemented operations involving data stored in computer systems. Furthermore, the embodiments described herein employ various computer-implemented operations which can be adapted to be part of a computer system, the cloud, etc. For example, these operations can require physical manipulation of physical quantities—usually, though not necessarily, these quantities can take the form of electrical or magnetic signals, where they or representations of them are capable of being stored, transferred, combined, compared, or otherwise manipulated. Further, such manipulations are often referred to in terms, such as producing, yielding, identifying, determining, comparing, receiving, storing, calculating, or generating. Any operations described herein that form part of one or more embodiments of the disclosure can be useful machine operations. In addition, one or more embodiments of the disclosure also relate to a device or an apparatus for performing these operations. The apparatus can be specially constructed for specific required purposes, or it can be a general purpose computer selectively activated or configured by a computer program stored in the computer. In particular, various general purpose machines can be used with computer programs written in accordance with the teachings herein, or it can be more convenient to construct a more specialized apparatus to perform the required operations.

The embodiments described herein can be practiced with other computer system configurations including hand-held devices, microprocessor systems, microprocessor-based or programmable consumer electronics, minicomputers, mainframe computers, and the like.

One or more embodiments of the present disclosure can be implemented as one or more computer programs or as one or more computer program modules embodied in one or more computer readable media. The term computer readable medium refers to any data storage device that can store data which can thereafter be input to a computer system—computer readable media can be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Disc), a CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present disclosure have been described in some detail for clarity of understanding, it will be apparent that certain changes and modifications can be made within the scope of the claims. Accordingly, the described embodiments are to be considered as illustrative and not restrictive, and the scope of the claims is not to be limited to details given herein, but can be modified within the scope and equivalents of the claims. In the claims, elements do not imply any particular order of operation, unless explicitly stated in the claims.

Many variations, modifications, additions, and improvements can be made. Plural instances can be provided for components, operations or structures described herein as a single instance. Boundaries between various components, operations and data stores are somewhat arbitrary, and particular operations are illustrated in the context of specific illustrative configurations. Other allocations of functionality are envisioned and can fall within the scope of the disclosure(s). In general, structures and functionality presented as separate components in exemplary configurations can be implemented as a combined structure or component. Similarly, structures and functionality presented as a single component can be implemented as separate components. It will be apparent to those skilled in the art that various modifications and variations can be made in the method and system of the disclosed subject matter without departing from the spirit or scope of the disclosed subject matter. These and other variations, modifications, additions, and improvements can fall within the scope of the appended claim(s) and their equivalents.

What is claimed is:

1. A method for monitoring and managing price levels, comprising:
receiving a plurality of call level indicators into a call level grid via a call level entry ticket, wherein the call level entry ticket tracks instruments within a market data grid and tracks a client and an account from a client-account grid, and wherein each call level indicator includes at least one user-defined parameter;
determining supported codes;
determining a priority for each call level indicator received, wherein the priority is based on factors derived from historic and real-time market data;
monitoring a price level related to each call level indicator received, wherein the monitoring is based on historic and real-time market data for each of the plurality of call level indicators received; and
initiating a call level alert upon a trigger or an expiry of the price level.

2. The method of claim 1, further comprising receiving instructions in response to the call level alert.

3. The method of claim 1, wherein each call level indicator has an audit trail attached thereto.

4. The method of claim 1, wherein the initiating of the call level alert includes preparing and sending a message via electronic mail or displaying a message via a desktop pop-up window.

5. The method of claim 4, wherein the initiating of the call level alert includes both preparing and sending the message via electronic mail and displaying the message via desktop pop-up window.

6. The method of claim 4, further comprising validating an addressee of the electronic mail prior to sending the message.

7. The method of claim 6, wherein the validating includes comparing the addressee against a broker or a user and an end client requesting the call level alert.

8. A computer system for monitoring and managing price levels, comprising:
a processor; and
a memory storing instructions that, when executed by the processor, cause the computer system to:
receive a plurality of call level indicators into a call level grid via a call level entry ticket, wherein the call level entry ticket tracks instruments within a market data grid and tracks a client and an account from a client-account grid, and wherein each call level indicator includes at least one user-defined parameter;
determine supported codes;
determine a priority for each call level indicator received, wherein the priority is based on factors derived from historic and real-time market data;
monitor a price level related to each call level indicator received, wherein the monitoring is based on historic and real-time market data for each of the plurality of call level indicators received; and
initiate a call level alert upon a trigger or an expiry of the price level.

9. The computer system of claim 8, further comprising receiving instructions in response to the call level alert.

10. The computer system of claim 8, wherein each call level indicator has an audit trail attached thereto.

11. The computer system of claim 8, wherein the initiating of the call level alert includes preparing and sending a message via electronic mail or displaying a message via a desktop pop-up window.

12. The computer system of claim 11, wherein the initiating of the call level alert includes both preparing and sending the message via electronic mail and displaying the message via desktop pop-up window.

13. The computer system of claim 11, further comprising validating an addressee of the electronic mail prior to sending of the message.

14. The computer system of claim 13, wherein the validating includes comparing the addressee against a broker or a user and an end client requesting the call level alert.

15. A non-transitory computer-readable medium storing instructions that, when executed by a processor, cause a computer system to monitor and manage price levels, by performing the steps of:
receiving a plurality of call level indicators into a call level grid via a call level entry ticket, wherein the call level entry ticket tracks instruments within a market data grid and tracks a client and an account from a client-account grid, and wherein each call level indicator includes at least one user-defined parameter;
determining supported codes;
determining a priority for each call level indicator received, wherein the priority is based on factors derived from historic and real-time market data;
monitoring a price level related to each call level indicator received, wherein the monitoring is based on historic and real-time market data for each of the plurality of call level indicators received; and
initiating a call level alert upon a trigger or an expiry of the price level.

16. The non-transitory computer-readable medium of claim 15, further comprising receiving instructions in response to the call level alert.

17. The non-transitory computer-readable medium of claim 15, wherein each call level indicator has an audit trail attached thereto.

18. The non-transitory computer-readable medium of claim 15, wherein the initiating of the call level alert includes preparing and sending a message via electronic mail or displaying a message via a desktop pop-up window.

19. The non-transitory computer-readable medium of claim 18, further comprising validating an addressee of the electronic mail prior to sending of the message.

20. The non-transitory computer-readable medium of claim 19, wherein the validating includes comparing the addressee against a broker or a user and an end client requesting the call level alert.
